(19) United States
(12) Patent Application Publication
(10) Pub. No.: US 2016/0044595 A1
(43) Pub. Date: Feb. 11, 2016

(54) Performance Monitoring System for Back-Up or Standby Engine Powered Wireless Telecommunication Networks

(71) Applicant: T-Mobile USA, Inc., Bellevue, WA (US)

(72) Inventor: Steve Fischer, Tampa, FL (US)

(21) Appl. No.: 14/456,415

(22) Filed: Aug. 11, 2014

(51) Int. Cl. H04W 52/02

(52) U.S. Cl. CPC H04W 52/0206

(57) ABSTRACT

A method of operating a communication unit within a wireless communication network. The method comprises activating, by a controller, an auxiliary power unit that includes an auxiliary power generator and generating, by the auxiliary power unit, auxiliary power. The method further comprises routing the auxiliary power for use by the communication unit and based upon one or more factors, controlling, by the controller, operation of the auxiliary power unit.

### BACKGROUND

In recent years, telecommunication devices have advanced from offering simple voice calling services within wireless networks to providing users with many new features. Telecommunication devices now provide messaging services such as email, text messaging, and instant messaging; data services such as Internet browsing; media services such as storing and playing a library of favorite songs; location services; and many others. In addition to the new features provided by the telecommunication devices, users of such telecommunication devices have greatly increased. Such increase in users is only expected to continue and in fact, it is expected that there could be a growth rate of twenty times more users in the next few years alone.

With the ever-increasing large number of users, it is important to provide service, especially at least emergency service, for the users within wireless networks. Thus, it is important that communication units, such as base stations, access points, etc., within wireless networks are able to operate even when power from a traditional power grid is lost due to various situations. While many communication units generally include auxiliary power units that are often expensive, such auxiliary power units generally cannot operate for long periods of time or are unreliable.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 schematically illustrates a wireless communication network, in accordance with various embodiments.

FIG. 2 schematically illustrates a macro cell of the wireless network of FIG. 1 arranged as a heterogeneous network divided into a plurality of pico cells, in accordance with various embodiments.

FIG. 3 schematically illustrates a self-healing network (SHN) 300 for controlling operation of various systems and components at a communication unit of the wireless network of FIG. 1, in accordance with various embodiments.

FIG. 4 is a flowchart illustrating an example method of operating the SHN of FIG. 3, in accordance with various embodiments.

### DETAILED DESCRIPTION

Described herein is a wireless communication network that includes architecture and methods for monitoring and controlling performance of back-up and/or standby power supplies for communication units within the wireless communication network via a self-healing network (SHN). In general, the SHN includes a controller that controls an auxiliary power unit (APU) system, where the APU system includes a standby generator that generates alternative power, such as, for example, direct current (DC) power that can be supplied to a DC system that includes, for example, batteries. The APU system can charge the batteries of the DC system when charge levels within the batteries drop below a certain point. The controller monitors the APU system and the DC system and can perform various tests of the APU system and the DC system in order to help ensure readiness of the two systems when needed, for example, during a power failure, severe weather, etc. The controller can also control various aspects of the communication unit such as, for example, the various radio access barriers (RABs), tilt of an antenna system of the communication unit, etc., in order to help control power consumption by the communication unit to thus help economize the power that can be generated by the APU system as the standby generator within the APU system generally has a limited supply of fuel. Additionally, the controller can help manage traffic handled by the communication unit to also further help economize power generated by the APU system. For example, the controller can pass traffic back and forth between the communication unit and a communication unit of a nearby communication cell. The apparatuses, networks and methods described herein are applicable to apparatuses, networks, and methods that operate in accordance with, for example, 3^{rd} Generation Partnership Project (3GPP) standards, 4^{th} Generation or Long Term Evolution (LTE) standards, etc. However, the apparatuses, networks and methods described herein are not limited to apparatuses, networks and methods that operate in accordance with 3GPP, 4G or LTE standards.

In an embodiment, in order to test the APU system and the DC system, the controller can periodically instruct the APU system to lower the voltage within the batteries of the DC system. The APU system will then detect the lower voltage of the batteries and will activate the standby generator in order to charge up the batteries back to an acceptable voltage level. In this manner, the controller can monitor and test the readiness and effectiveness of the APU system and the DC system. Such testing can be performed periodically, in anticipation of an upcoming severe weather event, etc.

Likewise, in the event of a power failure for the communication unit, the controller can help control various components and aspects of the communication unit in order to minimize power consumption by the communication unit. For example, the controller can “kill,” i.e. discontinue, handling of various RABs by the communication unit. Indeed, the controller can limit the communication unit to handling only an RAB that is for handling emergency wireless traffic. The controller can also manage the tilt of the antenna system of the communication unit in order to control power signals that are transmitted and/or received by the antenna system. Additionally, the controller can search for other nearby communication units within other communication cells of the wireless network in order to “hand off” wireless traffic to these other communication units to conserve power at the current communication unit and to allow the current communication unit to recharge the batteries. Thus, the controller can toggle the wireless traffic among various communication units of various communication cells within the wireless communication network in order to minimize power consumption at the various communication units and to allow the various communication units time to recharge their DC power supplies (batteries).

Thus, the architectures and techniques described herein can help test and maintain auxiliary power sources at a communication unit within a communication cell of a wireless network. Furthermore, the architectures and techniques described herein can help maximize and economize the amount of auxiliary power available at a communication unit within a communication cell of a wireless network. By economizing the auxiliary power available, users within the wireless communication network can receive a more consistent and higher level of quality of service even during a severe power outage.

### Example Operating Environment

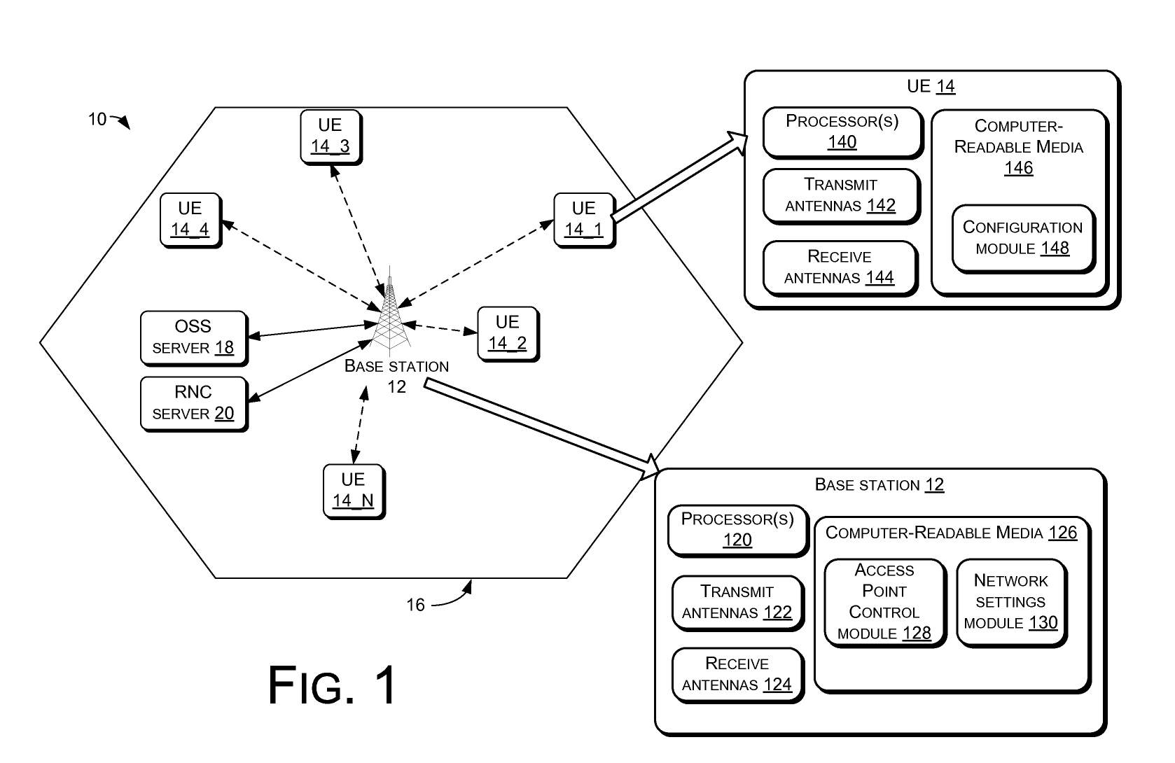

FIG. 1 schematically illustrates a wireless communication network 10 (also referred to herein as network 10). The network 10 comprises a base station (BS) 12 communicatively coupled to a plurality of user devices, referred to as UEs 14_1, 14_2, . . . , 14_N, where N is an appropriate integer. The BS 12 serves UEs 14 located within a geographical area, e.g., within a macro cell 16. FIG. 1 illustrates the macro cell 16 to be hexagonal in shape, although other shapes of the macro cell 16 may also be possible. In general, the network 10 comprises a plurality of macro cells 16, with each macro cell 16 including one or more BSs 12.

In an embodiment, the UEs 14_1, . . . , 14_N may comprise any appropriate devices for communicating over a wireless communication network. Such devices include mobile telephones, cellular telephones, mobile computers, Personal Digital Assistants (PDAs), radio frequency devices, handheld computers, laptop computers, tablet computers, palmtops, pagers, integrated devices combining one or more of the preceding devices, and/or the like. As such, UEs 14_1, . . . , 14_N may range widely in terms of capabilities and features. For example, one of the UEs 14_1, . . . , 14_N may have a numeric keypad, a capability to display only a few lines of text and be configured to interoperate with only Global System for Mobile Communications (GSM) networks. However, another of the UEs 14_1, . . . , 14_N (e.g., a smart phone) may have a touch-sensitive screen, a stylus, an embedded GPS receiver, and a relatively high-resolution display, and be configured to interoperate with multiple types of networks. UEs 14_1, . . . , 14_N may also include SIM-less devices (i.e., mobile devices that do not contain a functional subscriber identity module (“SIM”)), roaming mobile devices (i.e., mobile devices operating outside of their home access networks), and/or mobile software applications.

In an embodiment, the BS 12 may communicate voice traffic and/or data traffic with one or more of the UEs 14_1, . . . , 14_N. The BS 12 may communicate with the UEs 14_1, . . . , 14_N using one or more appropriate wireless communication protocols or standards. For example, the BS 12 may communicate with the UEs 14_1, . . . , 14_N using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

The BS 12 may be communicatively coupled (e.g., using a backhaul connection, illustrated using solid lines in FIG. 1) to a number of backhaul equipments, e.g., an operation support subsystem (OSS) server 18, a radio network controller (RNC) 20, and/or the like. The RNC 20 can also be in the form of a mobility management entity when the wireless communication network 10 operates according to the long term evolution (LTE) standard or LTE Advanced standard.

In an embodiment, the base station 12 may comprise processors 120, one or more transmit antennas (transmitters) 122, one or more receive antennas (receivers) 124, and computer-readable media 126. The processors 120 may be configured to execute instructions, which may be stored in the computer-readable media 126 or in other computer-readable media accessible to the processors 120. In some embodiments, the processors 120 are a central processing unit (CPU), a graphics processing unit (GPU), or both CPU and GPU, or any other sort of processing unit. The base station 12 can also be in the form of a Node B (where the wireless communication network 10 is 3G UMTS network) or in the form of an eNode B (where the wireless communication network 10 operates according to the LTE standard or LTE Advanced standard).

The one or more transmit antennas 122 may transmit signals to the UEs 14_1, . . . , 14_N, and the one or more receive antennas 124 may receive signals from the UEs 14_1, . . . , 14_N. The antennas 122 and 124 include any appropriate antennas known in the art. For example, antennas 122 and 124 may include radio transmitters and radio receivers that perform the function of transmitting and receiving radio frequency communications. In an embodiment, the antennas 122 and 124 may be included in a transceiver module of the BS 12.

The computer-readable media 126 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the base station 12. The computer-readable media 126 may reside within the base station 12, on one or more storage devices accessible on a local network to the base station 12, on cloud storage accessible via a wide area network to the base station 12, or in any other accessible location.

The computer-readable media 126 may store modules, such as instructions, data stores, and so forth that are configured to execute on the processors 120. For instance, the computer-readable media 126 may store an access point control module 128 and a network settings module 130, as will be discussed in more detail herein later.

Although FIG. 1 illustrates the computer-readable media 126 in the BS 12 storing the access point control module 128 and the network settings module 130, in various other embodiments, the access point control module 128, the network settings module 130, and one or more other modules (not illustrated, may be stored in another component of the network 10 (e.g., other than the BS 12). For example, one or more of these modules may be stored in a computer-readable media included in the OSS server 18, the RNC 20, another appropriate server associated with the network 10, and/or the like.

Although not illustrated in FIG. 1, various other modules (e.g., an operating system module, basic input/output systems (BIOS), etc.) may also be stored in the computer-readable media 126. Furthermore, although not illustrated in FIG. 1, the base station 12 may comprise several other components, e.g., a power bus configured to supply power to various components of the base station 12, one or more interfaces to communicate with various backhaul equipments, and/or the like.

In an embodiment, the UEs 14 may comprise processors 140, one or more transmit antennas (transmitters) 142, one or more receive antennas (receivers) 144, and computer-readable media 146. The processors 140 may be configured to execute instructions, which may be stored in the computer-readable media 146 or in other computer-readable media accessible to the processors 140. In some embodiments, the processors 140 is a central processing unit (CPU), a graphics processing unit (GPU), or both CPU and GPU, or any other sort of processing unit. The one or more transmit antennas 142 may transmit signals to the base station 12, and the one or more receive antennas 144 may receive signals from the base station 12. In an embodiment, the antennas 142 and 144 may be included in a transceiver module of the UE 14.

The computer-readable media 146 may also include CRSM. The CRSM may be any available physical media accessible by a computing device to implement the instructions stored thereon. CRSM may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 14.

The computer-readable media 146 may store several modules, such as instructions, data stores, and so forth that are configured to execute on the processors 140. For instance, the computer-readable media 140 may store a configuration module 148. Although not illustrated in FIG. 1, the computer-readable media 146 may also store one or more applications configured to receive and/or provide voice, data and messages (e.g., short message service (SMS) messages, multi-media message service (MMS) messages, instant messaging (IM) messages, enhanced message service (EMS) messages, etc.) to and/or from another device or component (e.g., the base station 12, other UEs, etc.).

Although not illustrated in FIG. 1, the UEs 14 may also comprise various other components, e.g., a battery, a charging unit, one or more network interfaces, an audio interface, a display, a keypad or keyboard, a GPS receiver and/or other location determination component, and other input and/or output interfaces.

Although FIG. 1 illustrates only one UE (UE 14_1) in detail, each of the UEs 14_2, . . . , 14_N may have a structure that is at least in part similar to that of the UE 14_1. For example, similar to the UE 14_1, each of the UEs 14_2, . . . , 14_N may comprise processors, one or more transmit antennas, one or more receive antennas, and computer-readable media including a configuration module.

In an embodiment, the network settings module 130 stored in the computer-readable media 126 maintains a plurality of network settings associated with the network 10. Individual network settings maintained by the network settings module 130 may be pertinent to a single UE of the UEs 14_1, . . . , 14_N, a subset of the UEs 14_1, . . . , 14_N, or each of the UEs 14_1, . . . , 14_N. For example, a network setting of the plurality of network settings may specify a maximum bit rate at which a UE (or each of the UEs 14_1, . . . , 14_N) may transmit data to the BS 12. Another network setting of the plurality of network settings may specify a transmit time interval (tti) used by each of the UEs 14_1, . . . , 14_N to transmit data to the BS 12. Yet another network setting of the plurality of network settings may specify a maximum power that each of the UEs 14_1, . . . , 14_N may use to transmit data to the BS 12. The plurality of network settings maintained by the network settings module 130 may also include any other appropriate type of network settings.

In an embodiment, one or more of the plurality of network settings maintained by the network settings module 13 may be communicated to the UEs 14_1, . . . , 14_N (e.g., by the transmit antennas 122 to the receive antennas 144 of the UEs 14_1, . . . , 14_N). Based on receiving the network settings, the UEs 14_1, . . . , 14_N (e.g., the corresponding configuration modules 148) may configure themselves and communicate with the BS 12 accordingly.

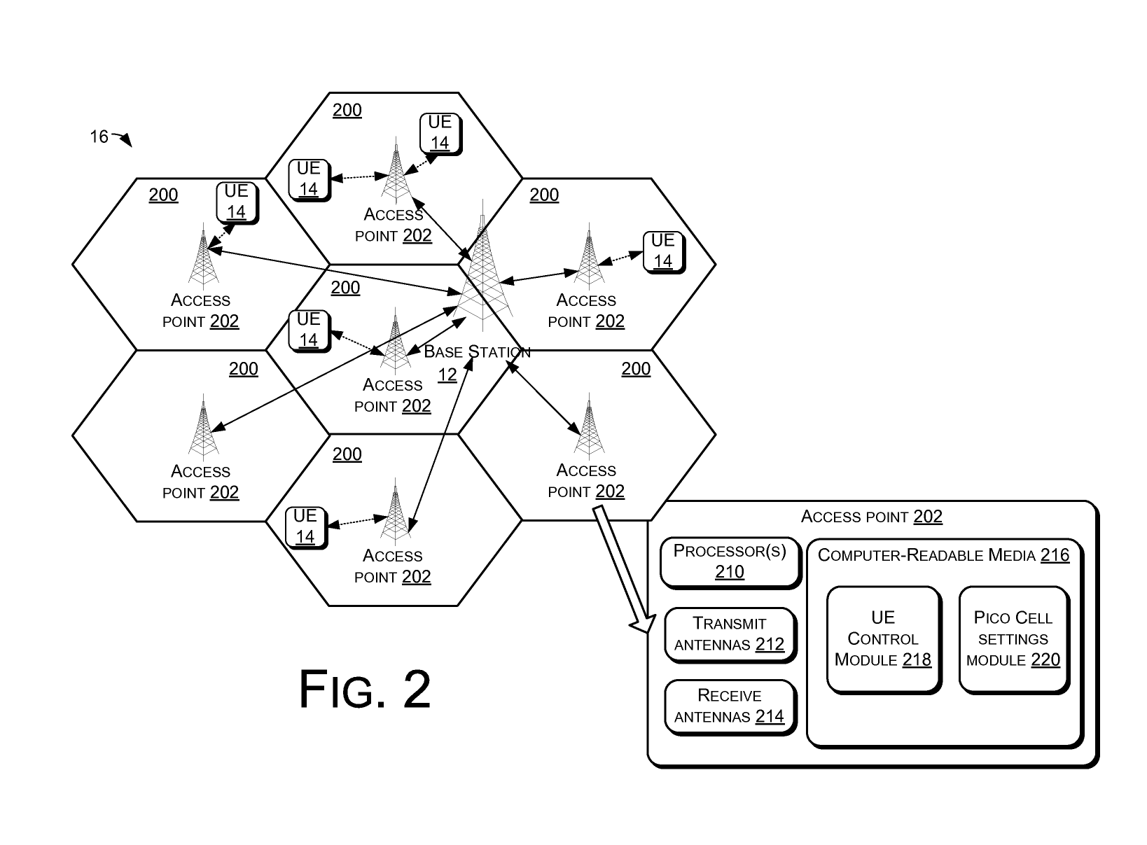

FIG. 2 schematically illustrates the macro cell 16 arranged as a heterogeneous network. The macro cell 16 is divided into a plurality of smaller cells referred to as pico cells 200. Each pico cell 200 includes an access point 202, which is generally a lower power node with respect to the BS 12, which serves as a higher power node for the network 10. Each access point 202 controls and handles transmission of signals within a corresponding pico cell 200. While the macro cell 16 is illustrated as including six pico cells 200, more or fewer pico cells 200 may be included.

As with the BS 12, in an embodiment, each access point 202 may communicate voice traffic and/or data traffic with one or more of the UEs 14 that are located within its corresponding pico cell 200. The access point 200 may communicate with the UEs 14 using one or more appropriate wireless communication protocols or standards. For example, the access point 200 may communicate with the UEs 14 using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

The access points 202 are generally communicatively coupled (e.g., using a backhaul connection, illustrated using solid lines in FIG. 2) to the BS 12. The backhaul connection may include a fiber optic communication channel, a hard wire communication channel, etc.

In an embodiment, the access points 202 may comprise processors 210, one or more transmit antennas 212, one or more receive antennas 214, and computer-readable media 216. The processors 210 may be configured to execute instructions, which may be stored in the computer-readable media 216 or in other computer-readable media accessible to the processors 210. In some embodiments, the processors 210 are a central processing unit (CPU), a graphics processing unit (GPU), or both CPU and GPU, or any other sort of processing unit.

The one or more transmit antennas 212 may transmit signals to the UEs 14, and the one or more receive antennas 214 may receive signals from the UEs 14. The antennas 212 and 214 include any appropriate antennas known in the art. For example, antennas 212 and 214 may include radio transmitters and radio receivers that perform the function of transmitting and receiving radio frequency communications. In an embodiment, the antennas 212 and 214 may be included in a transceiver module of the access points 202.

The computer-readable media 216 for each access point 202 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the access point 202. The computer-readable media 216 may reside within the access point 202, on one or more storage devices accessible on a local network to the access point 202, on cloud storage accessible via a wide area network to the access point 202, or in any other accessible location.

The computer-readable media 216 may store modules, such as instructions, data stores, and so forth that are configured to execute on the processors 210. For instance, the computer-readable media 216 may store a UE control module 218 and a pico cell settings module 220, as will be discussed in more detail herein later.

Although not illustrated in FIG. 2, various other modules (e.g., an operating system module, basic input/output systems (BIOS), etc.) may also be stored in the computer-readable media 216. Furthermore, although not illustrated in FIG. 2, each access point 202 may comprise several other components, e.g., a power bus configured to supply power to various components of the access point 202, one or more interfaces to communicate with various backhaul equipments, and/or the like.

In an embodiment, the pico cell settings module 220 stored in the computer-readable media 216 maintains a plurality of pico cell settings associated with a corresponding pico cell 200. Individual pico cell settings maintained by the pico cell settings module 220 may be pertinent to a single UE of the UEs 14, a subset of the UEs 14, or each of the UEs 14. For example, a pico cell setting of the plurality of pico cell settings may specify a maximum bit rate at which a UE (or each of the UEs 14) may transmit data to the corresponding access point 200. Another pico cell setting of the plurality of pico cell settings may specify a transmit time interval (tti) used by each of the UEs 14 to transmit data to the corresponding access point 200. Yet another pico cell setting of the plurality of pico cell settings may specify a maximum power that each of the UEs 14 may use to transmit data to the corresponding access point 200. Another pico cell setting may include a frequency or spectrum to sue for transmission and reception of signals within the corresponding pico cell 200, as well as a channel within the spectrum. The plurality of network settings maintained by the pico cell settings module 220 may also include any other appropriate type of pico cell settings.

In an embodiment, one or more of the plurality of pico cell settings maintained by the pico cell settings module 220 may be communicated to the UEs 14 (e.g., by the transmit antenna 212 to the configuration modules 148 of the UEs 14). Based on receiving the pico cell settings, the UEs 14 (e.g., the corresponding configuration modules 148) may configure themselves and communicate with the corresponding access point 200 accordingly.

In an embodiment, the access point control module 128 of the BS 12 controls the access points 200. For example, the access point control module 128 may provide procedures for communicating with the BS 12, procedures for handing off UEs 14 to the BS 12, procedures for handing off UEs among the various pico cells 200 and access points 202, etc. Likewise, the UE control module 218 of the access points controls the UEs 14 within the respective pico cells. For example, the UE control module 218 may provide procedures for communicating with the corresponding access point 200, procedures for handing off UEs 14 to the BS 12, procedures for handing off UEs among the various pico cells 200 and access points 202, etc.

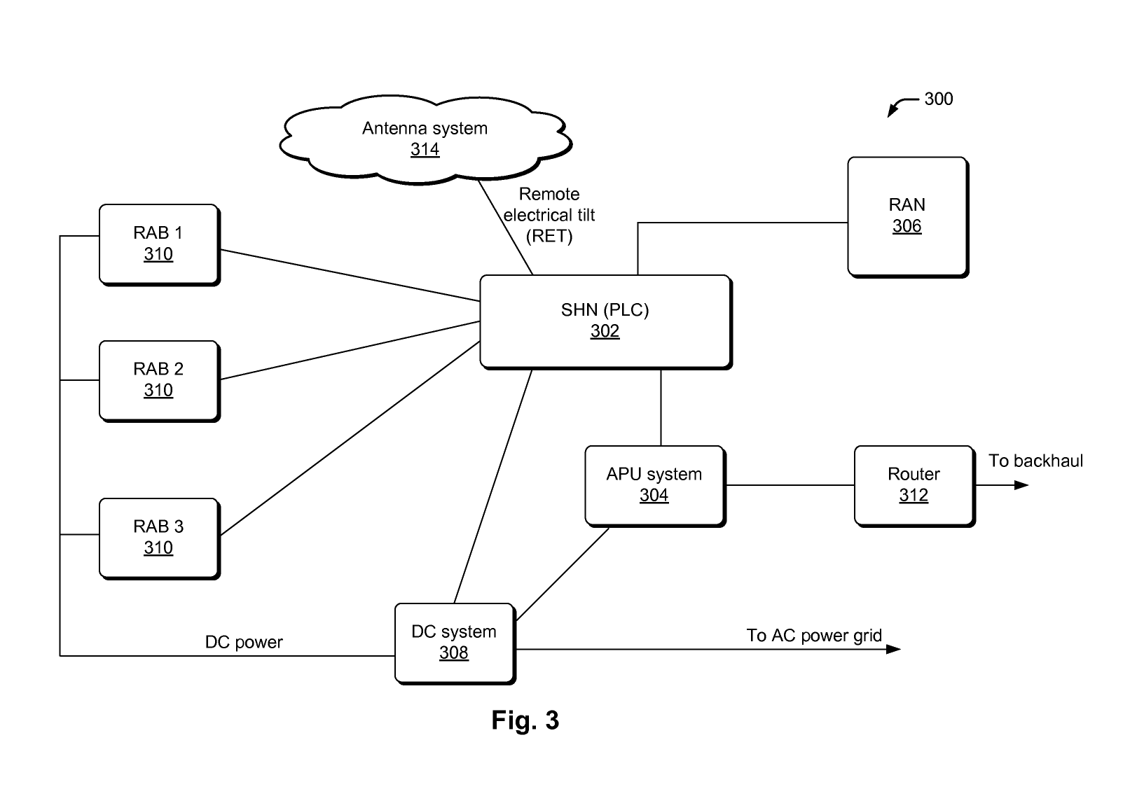

FIG. 3 schematically illustrates a self-healing network (SHN) 300 for controlling operation of various systems and components at a communication unit of a wireless network such as, for example, a base station 12, an access point 202, etc. The SHN network 300 includes a SHN programmable logic controller (PLC) 302. The SHN PLC 302 is in communication with an auxiliary power unit (APU) system 304. The SHN PLC 302 is also in communication with a radio access network (RAN) 306, a direct current (DC) system 308 and a plurality of radio access barriers (RAB) 310. The radio access barriers generally refer to the wireless standards that can be utilized within the wireless communication network 10, e.g., long-term evolution (LTE), fourth generation (4G), third generation (3G), etc. The DC system 308 generally consists of one or more batteries (not illustrated) for providing DC power to the communication unit when needed. The APU system 304 is also in communication with the DC system 308. The DC system 308 is also generally in communication with the power grid, i.e., a general alternating current (AC) power supply network that generally provides power to the communication unit. The APU system 304 is further in communication with a router 312. The SHN PLC 302 is also in communication with an antenna system 314 of the communication unit of the network 10.

The APU system 304 is configured to generate power. Thus, the APU system 304 generally includes a standby power generator (not illustrated). The power generator generally operates on some type of fuel such as, for example, oil, gasoline, propane gas, etc. Thus, in the event that power from the power grid is unavailable, power can be provided from the batteries in the DC system 308. Alternatively, power generated by the standby generator of the APU system can be provided for direct use by the communication unit. The APU system 304 can be activated by the SHN PLC 302 such that the power generator begins generating power to help provide power to the batteries within the DC system 308. However, as the amount of fuel to operate the generators within the APU system 304 is limited, it is desirable to maximize the amount of power generated by the fuel and to utilize the batteries' power to operate the communication unit in an efficient manner.

### Example Operations

In accordance with various embodiments, if a power failure occurs, thereby necessitating the need for the communication unit to utilize power from the DC system 308, the RAN 306 can communicate with the SHN PLC 302 via an SHN-IN link between the RAN 306 and the SHN PLC 302. The SHN PLC 302 can then activate the APU system 304. The SHN PLC 302 can also “kill” various RABs 310 to thereby conserve power consumed by the communication unit. In other words, by eliminating some of the RABs 310, fewer communications can be handled by the communication unit. In extreme emergencies, the SHN PLC 302 may only allow an RAB 310 that handles emergency communications to be handled by the communication unit.

While operating, the SHN PLC 302 can control the APU system 304 to turn on and off to charge the batteries in the DC system 308 based upon voltage levels within the batteries. For example, the SHN PLC 302 can activate the APU system 304 when voltage levels within the batteries of the DC system 308 drop to a certain level. Once the voltage levels of the batteries of the DC system 308 are charged back to a certain level, the SHN PLC 302 can shut down the APU system 304. The APU system 304 can also automatically activate itself based upon voltage levels within the batteries of the DC system 308 detected either by the SHN PLC 302 or the APU system 308.

Furthermore, the SHN PLC 302 can communicate via the RAN 306 to see if an adjacent cell 200 with a communication unit within the network 10 can handle traffic. If all neighboring cells 200 are also suffering from power outages and thus, are being operated by APUs, the SHN PLC 302 can toggle traffic back and forth between the various cells 200 to help extend the auxiliary power available for all of the cells 200. In other words, each cell 200 can handle some wireless traffic for a predetermined amount of time but then can pass it off to another cell 200 and then possibly recharge its own batteries. After recharging the batteries, wireless traffic can be rerouted back to the cell 200. Such an operation can help maintain performance for the wireless traffic within the network 10. The router 112 can communicate via the backhaul to the RAN 306 in order to monitor for when various communication cells are operating to thereby help with the toggling and passing of communication traffic among the communication cells.

The SHN PLC 302 can also communicate with the RAN 306 in order to determine when the APU system 304 is needed or is no longer needed. An alarm line is provided between the SHN PLC 302 and the RAN 306 to signal alarms from the SHN PLC 302 to the RAN 306 that the APU system 304 is needed and being utilized. A communication line is also provided between the SHN PLC 302 and the RAN 306 to provide monitoring information related to the APU system 304 to the RAN 306. The SHN PLC 302 also has a communication line with the antenna system 314 of the communication unit that can allow for remote electrical tilt (RET) of the antenna system 314. The RET of the antenna system 314 can allow for preservation of power from the APU system 308 by controlling various types and aspects of the wireless communication signals handled by the communication unit.

In accordance with various embodiments, the SHN PLC 302 communications with the APU system 308 in order to test and monitor the APU system 308's readiness for operation. For example, if a major storm is predicted for the area, the SHN PLC 302 can perform a pre-storm check on the APU system 304 by activating the APU system 304. In such a scenario, the SHN PLC 302 can send a signal to the DC system 308 in the form of a voltage drop command to cause the batteries to drop their voltage to a predetermined level. The APU system 304 will then realize that the batteries have dropped to a predetermined level and will activate itself to generate voltage to charge the batteries. Once the batteries are charged back up to an acceptable predetermined level, then the APU system 304 can cease operation. If for some reason there is a problem with the APU system 304, then the SHN PLC 302 can activate an alarm so that appropriate steps can be taken to rectify or fix the situation. Likewise, the SHN PLC 302 can monitor the APU system 304 for APU faults, fuel levels, oil problems, problems within the generator, etc.

### Example Processes

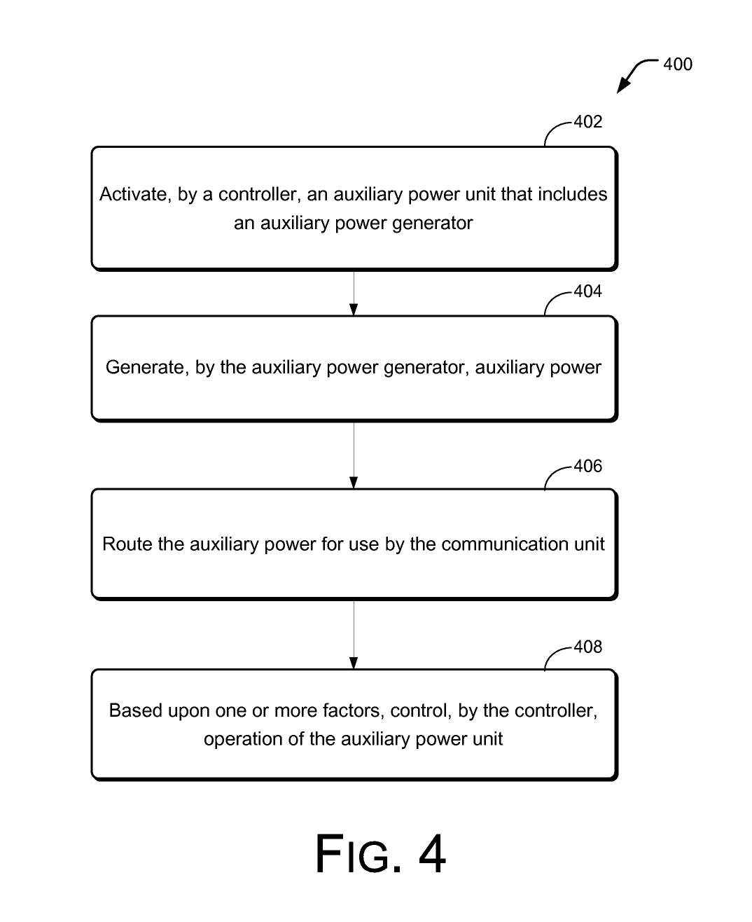

FIG. 4 is a flow diagram of an illustrative example process that may be implemented within the wireless network 10. This process (as well as other processes described throughout herein) is illustrated as a logical flow graph, each operation of which represents a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Furthermore, while the architectures and techniques described herein have been described with respect to wireless networks, the architectures and techniques are equally applicable to processors and processing cores in other environments and computing devices.

FIG. 4 is a flowchart illustrating a method 400 of operating a communication unit within a wireless communication network, in accordance with various embodiments. As illustrated, at block 402, a controller activates an auxiliary power unit that includes an auxiliary power generator. At block 404, the auxiliary power unit generates auxiliary power. At block 406, the auxiliary power is routed for use by the communication unit. At block 408, based upon one or more factors, the controller controls operation of the auxiliary power unit.

While the techniques, operations and processes described herein have been described with respect to macro cells and pico cells within a macro cell of a wireless network, it is to be understood that the techniques, operations and processes described herein can be used with any type of cell, access point and base station within a wireless network. For example, the techniques, operations and processes described herein can be used with respect to a macro cell, a base station and user devices within the macro cell without the use of pico cells and/or access points. Additionally, base stations can serve as or include access points.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

I claim:

1. A method of operating a communication unit within a wireless communication network, the method comprising:
activating, by a controller, an auxiliary power unit that includes an auxiliary power generator;
generating, by the auxiliary power unit, auxiliary power;
providing the auxiliary power for use by the communication unit; and
based upon one or more factors, controlling, by the controller, operation of the auxiliary power unit.

2. The method of claim 1, wherein providing the auxiliary power for use by the communication unit comprises providing the auxiliary power to one or more batteries.

3. The method of claim 2, wherein the one or more factors comprise a voltage level within the one or more batteries.

4. The method of claim 1, wherein providing the auxiliary power for use by the communication unit comprises providing the auxiliary power for direct use by the communication unit.

5. The method of claim 1, wherein activating, by a controller, an auxiliary power unit that includes an auxiliary power generator comprises activating, by the controller, the auxiliary power unit for purposes of testing the auxiliary power unit.

6. The method of claim 5, wherein;
providing the auxiliary power for use by the communication unit comprises providing the auxiliary power to one or more batteries; and
the one or more factors comprise a voltage level within the one or more batteries.

7. The method of claim 1, wherein the one or more factors include availability of a primary source of power.

8. The method of claim 1, further comprising:
determining, by the controller, availability of one or more other communication units within the wireless network; and
transferring wireless traffic from the communication unit to one or more of the one or more other communication units within the wireless network.

9. The method of claim 8, wherein the one or more factors include a level of wireless traffic at the communication unit.

10. The method of claim 1, further comprising:
altering, by the controller, tilt of an antenna system of the communication unit.

11. The method of claim 1, further comprising:
blocking, by the controller, one or more radio access barriers handled by the communication unit.

12. The method of claim 11, wherein the controller only allows emergency wireless traffic.

13. An apparatus at a communication unit within a wireless communication network, the apparatus comprising:
a tangible storage medium; and
instructions stored in the tangible storage medium, the instructions being executable by the apparatus to
activate an auxiliary power unit that includes an auxiliary power generator,
route the auxiliary power for use by the communication unit, and
based upon one or more factors, control operation of the auxiliary power unit.

14. The apparatus of claim 13, wherein the auxiliary power is routed to one or more batteries.

15. The apparatus of claim 14, wherein the one or more factors comprise a voltage level within the one or more batteries.

16. The apparatus of claim 13, wherein the auxiliary power is routed for direct use by the communication unit.

17. The apparatus of claim 13, wherein the instructions are configured to activate the auxiliary power unit for purposes of testing the auxiliary power unit.

18. The apparatus of claim 17, wherein;
the auxiliary power is routed to one or more batteries; and
the one or more factors comprise a voltage level within the one or more batteries.

19. The apparatus of claim 13, wherein the one or more factors include availability of a primary source of power.

20. The apparatus of claim 13, the instructions are further executable by the apparatus to:
determine availability of one or more other communication units within the wireless network; and
transfer wireless traffic from the communication unit to one or more of the one or more other communication units within the wireless network.

21. The apparatus of claim 20, wherein the one or more factors include a level of wireless traffic at the communication unit.

22. The apparatus of claim 13, the instructions are further executable by the apparatus to:
alter tilt of an antenna system of the communication unit.

23. The apparatus of claim 13, the instructions are further executable by the apparatus to:
block one or more radio access barriers handled by the communication unit.

24. The apparatus of claim 23, wherein the instructions are further executable by the apparatus to only allow emergency wireless traffic.
